(19) United States
(12) Patent Application Publication
(10) Pub. No.: US 2014/0220516 A1
(43) Pub. Date: Aug. 7, 2014

(54) SYSTEM AND METHOD FOR FOOD ITEM SEARCH WITH NUTRITIONAL INSIGHT ANALYSIS USING BIG DATA INFRASTRUCTURE

(71) Applicants: Kenneth Rapp Marshall, Kentfield, CA (US); Edmond Trey Dempsey, Dallas, TX (US); Charlie Robert Collins, Nashville, TN (US); Elizabeth Marie Turner, San Jose, CA (US)

(72) Inventors: Kenneth Rapp Marshall, Kentfield, CA (US); Edmond Trey Dempsey, Dallas, TX (US); Charlie Robert Collins, Nashville, TN (US); Elizabeth Marie Turner, San Jose, CA (US)

(73) Assignee: FoodCare Inc., Louisville, KY (US)

(21) Appl. No.: 13/845,011

(22) Filed: Mar. 17, 2013

Related U.S. Application Data
(60) Provisional application No. 61/759,698, filed on Feb. 1, 2013.

(51) Int. Cl. G09B 19/00

(52) U.S. Cl. CPC G09B 19/0092
USPC 434/127

(57) ABSTRACT

A nutritional insight recommendation system using map-reduce software to calculate increasingly large user base and food items to provide real-time updates on nutritional guidelines. The system provides a universal system that use and share data among end users, nutritionists and dieticians, food service providers (such as restaurants) and manufacturers, and health providers and government entities.

### CROSS-REFERENCE TO RELATED APPLICATIONS

This application claims priority to a U.S. Provisional Application 61/759,698, filed on Feb. 2, 2013.

### BACKGROUND OF INVENTION

In a society where the nuanced dietary preferences and restrictions of tens of millions of Americans grow more unique, and vitally important, by the day, the difficulty for people to find food and manage their diet is made more complicated each day. Over 150 million Americans suffer from at least one nutrition-related chronic disease or health condition, and millions have one or more such conditions. Americans dietary preferences are growing more complex, as individuals search for foods with or without certain additives, processed in a certain way or not in a certain way, sourced locally or sustainably or in an ethical manner. There are more food items than ever, there are more dietary profiles than ever, yet existing software has not presently delivered any solutions that are technologically capable of computationally calculating and rapidly delivering comprehensive nutritional insights across all types of food items that is further capable of providing dynamically adaptive nutrition guidance to people during the course of a day, a week, or a longer period of time.

The Department of Health and Human Services reports that about 25% of Americans have two or more chronic diseases, which by definition require continuing medical care and closer dietary supervision. In these instances, the guidance of a Registered Dietitian or otherwise qualified medical professional is often essential. For these individuals, dietary guidance grows ever more complex, as the nuanced dietary guidelines and recommendations for multiple conditions, coupled with specific vital statistics of the individual patient, must all be considered and combined into one dietary guideline. Existing arts have not anticipated the technological infrastructure challenges associated with enabling an extremely large number of simultaneous users to have personalized dietary guidelines stored in a software infrastructure such that the users can access their profiles and view food items through the lens of their dietary target ranges accurately and rapidly. With billions of smart mobile device currently available, it is foreseeable that a data application can have up to a million users simultaneously, if not more.

This same computational challenge extends to non-clinical users who have multiple types of personal dietary preferences (ex., organic, vegan, non-GMO, fair-trade, additive free, etc.), and of course to individuals who have both clinical needs and personal dietary preferences.

The specific system requirements necessary to compute and deliver dynamically adaptable dietary guidance is also something that no previously existing software realize to be a problem that needs to be solved. Particularly, where the infrastructure of the system is capable of adjusting dietary guidelines in real-time throughout the course of a day based on previous food logged or other considerations.

Current nutrition solutions consider the logging of food items throughout the course of a day, in certain cases alerting the user to the surpassing of nutrient thresholds via a visual element. However, simply logging food items and keeping track of different nutrients against a daily nutrition threshold is in many instances an inappropriate and short-sighted view of the needs of the user. In the course of a day or week, individuals do not eat each meal against the same nutrition standard. While at the end of a day a user aspires to be “compliant” with the dietary guidelines outlined for them, but how they get there can happen an infinite number of ways. For example, a person could have a “heavy” breakfast, followed up by light lunches, snacks and dinner, and be in compliance with their guidelines. Conversely, a user, knowing that he or she will have a very large dinner, could plan for a light breakfast and lunch in advance of the dinner. Thus a computing system capable of providing users with dynamically adaptive nutrition insights on food items capable of rapidly analyzing, and re-analyzing comparisons of food items against the dietary guidance of the person across thousands of food items as a user logs a variety of food items has not been done in the realm of nutrition computing.

In addition to the needs of consumers (as eaters), are chefs—whether they be foodservice professionals working in restaurants, food scientists working for a food manufacturer, corporate or school cafeteria chefs, chefs in a healthcare setting, or someone just cooking at home for their extended family, also desire to understand which of their dishes are appropriate for a wide-variety of special dietary restrictions in the interest of maximizing their ability to meet the needs of their diners. Current software solutions in the field of foodservice or consumer nutrition analysis does not contemplate the professional needs of recipe innovators seeking to create dishes with advanced dietary restrictions in mind that is capable of computationally comparing food items against a broad cross-section of dietary profiles accurately and rapidly.

The present invention solves the problems that are not yet solved, let alone identified, in the existing arts by realizing that in order to transform the dietary well-being of an individual, a patient population, or the nation, the current food system itself must be transformed in terms of providing diners with healthier food options wherever one acquires or consumes food. Therefore, it is desirable to integrate the type of basic nutrition analysis functionality already well known in the field, with insights into how to target market specific food items to specific user populations, guidance to how to make food items appropriate for larger audiences of consumers (by reconfiguring the ingredients to meet specific needs), and by specifically quantifying the relationship between market potential and meal costs and profitability. This also helps larger foodservice businesses and large communities of chefs to collaborate with each other and third party partners to create dietary restrictive specific meal items and gather feedback from each other, partners and consumers.

The present invention further recognizes that in a world increasingly focused on disease prevention and management, health care providers are better recognizing the nutrition needs of their patient populations (and the community surrounding them), and the importance of the role of the Registered Dietitian (“RD”) in providing personalized nutrition guidance to consumers (patients). The present invention enables RDs to be fully integrated into both the lives of their clients and patients, as well as in the food system surrounding them. Using the present invention RDs can provide personalized dietary guidance, supported by the requisition big data computational capabilities required to enable a high performing solution that delivers nutrition insight data wherever the consumer user requires it. Furthermore, another important feature in this present invention allows RDs to provide consultative support to any foodservice setting (restaurants, grocers, food manufacturers, cafeterias, etc.), and to create recipes themselves and socially share them via web, mobile or social apps with specific patients or patient populations.

It is another feature of this present invention to enable the RDs, Dietitians, and other health professionals and interested parties to directly engage with individuals and patient populations to help them transform their dietary well-being in ways that are specifically appropriate for their dietary restrictions.

### HISTORY OF RELEVANT PRIOR ARTS

U.S. Pat. No. 6,980,999 (to Grana) discloses a method and system for providing dietary information; U.S. patent application Ser. No. 12/954,881 (to Adamowicz) discloses a personalized food identification and nutrition guidance system; U.S. patent application Ser. No. 13/252,620 (to Abujbara) discloses a personal nutrition and wellness advisor; each of which is herein incorporated by reference in its entirety, relating to dietary information generally.

Each of these references has serious deficiencies and none provide the required technological needs in providing the backbone for large amount of nutritional analysis for a large amount of simultaneous users of the present invention.

### SUMMARY OF THE INVENTION

The present invention uses a “Big Data” approach to use the clinical dietary guidelines related to the health conditions of a particular health population, or guidelines set by an individual dietitian (or otherwise qualified health professional), or any other dietary preference of the individual, to provide accurate nutrition insights for any number of food items that are relevant to either a population that shares the same dietary profile, or to a specific user.

A user creates a profile with the end user software application, or has a profile automatically generated through an interface between the software application and a third party data service which the user has authorized to share known key data elements with the application, the user supplements this information with personal dietary preferences, and one or more specific health conditions, and dietary guidelines that apply to the user are generated and stored. End user software in this case means software that is available for the general public use, and to distinguish it from other variations of the versions for professional users in the foodservice industry or health care.

When a user has a request for a grouping of food items or specific food item, the system performs an “N-number” of required comparison calculations across all food data items in the database, using the users dietary guidelines as key data inputs, and then returns food options from the database and indicates how various food options compare to the recommended dietary guidelines stored in the database to the user, and provides specific visual context for how food options compare with meal requirements, typically for a standard meal (per the users standard, per meal dietary guideline). Here the N-number is defined as the number of all the food items in the database, all the dietary guidelines in the database, and all user profiles available in the database. It should be clear that as the number of users and food items grow into increasingly large numbers, the infrastructure can not only grow with the data population, but can return the results to the users at a very low response time.

The system has another layer of feature in the form of dynamic meal logging. As the user inputs food items he or she has consumed during the day to the system, the system will incorporate the amount of nutrients present in the consumed food item to its calculations. The user can then see simultaneously (1) the amount of nutrients he or she have left for the day, or in some cases the amount of nutrient that he or she needs to consume before meeting the daily intake requirements, and (2) the available food items he or she can eat and stay within the recommended guidelines assigned to his or her profile.

The present invention allows foodservice operators, healthcare professionals, third party apps and devices, and the layperson to search for, create, publish, analyze, and report on the relevance of any specific food item to any specific health condition or personalized dietary restriction of any sort, leveraging advanced methods required to dynamically perform innumerable computational calculations in real-time, and further uses machine-based learning and behavioral science to guide individuals and patient populations towards better dietary-related decisions.

In order to allow the system to perform a large amount of comparisons of food items against guidelines, it uses a software framework that supports data-intensive distributed applications and capable of running of applications on large clusters of commodity hardware. An example of such software can be found in the open source system known as Apache Hadoop, although similar framework can be used as well by someone skilled in the art.

The system uses a computational paradigm of map-reduce, in which the application is divided into many small fragments of work, each of which may be executed or re-executed on any node in the cluster. Map-reduce is a framework for processing parallelizable problems across huge datasets using a large number of computers (or nodes), collectively referred to as a cluster (if all nodes are on the same local network and use similar hardware) or a grid (if the nodes are shared across geographically and administratively distributed systems, and use more heterogeneous hardware).

In the “map” step, the master node takes the input, divides it into smaller sub-problems, and distributes them to worker nodes. A worker node may do this again in turn, leading to a multi-level tree structure. The worker node processes the smaller problem, and passes the answer back to its master node. In the “reduce” step, the master node then collects the answers to all the sub-problems and combines them in some way to form the output—the answer to the problem it was originally trying to solve.

One advantage of having such software framework is scalability. Because the framework comprises of a plurality of clusters and grids, the framework can be expanded or reduced proportionally depending on the required computing power based on the size of the user base and data that need to be processed. New clusters and grids can be added to the framework on peak times, and inversely existing grids and clusters can be set on standby during off times.

Using such software framework, the system can perform an enormous amount of calculations and return the results almost instantaneously to the users. In one possible instance, a user first creates a profile of his or her health information that the infrastructure then selects one or more guidelines that match the profile. Once the guidelines are selected and saved to the user profile, the profile is then used as a filter for any data that meet the nutritional guidelines defined in the user profile. The user's screen then displays all the results coming from the entire process.

Thus, instead of processing every single data on every single query a user make, the system utilizes a user's health profile to sort data that meet the user's health requirements and subsequently returns results within the universe defined in the user's health profile. The software framework further allows the system to process any additional data that is added to the database in real-time, independent of a particular user's activity in the infrastructure. Therefore, on each query the user obtains near instantaneous results from the system or at most, no more than a few seconds of getting the results he or she is looking for.

A typical user may access the system through web, mobile or social platforms, and interfaces with the system to search for food items, engage with local and national food communities, and to embark on the transformation of their dietary well-being. The system enables users to add multiple food items to estimate appropriateness of the grouping of food items into a single meal, and dynamically re-calculate dietary appropriateness for each and every food item and recipe in the database for subsequent meals, and store and log such items for subsequent data analysis and dietary or lifestyle guidance. It further enables them to search for, create and share recipes that are appropriate for specific dietary restrictions of patient populations or individual dietary restrictions. Finally, it provides for the requisite infrastructure necessary to perform these searches quickly, and even add the special dietary needs of other friends and family members joining them for a meal, and quickly return food items and recipes that meet the needs of multiple individuals.

In smart mobile devices that have location awareness features such as GPS and the like, the system can take advantage of such features by using the user's current location to recommend restaurants, stores and other food establishments that is within the user's geographical area.

Food Service users including restaurant owners, chefs, and other food providers have additional features in the software, particularly the ability to disclose and publish nutritional guidelines to their dishes on the mobile application, and use the nutritional guidelines to create dishes that are within the recommended boundaries of healthy eating for a particular health condition. Another Food Service feature also allows restaurants to keep track of the amount of people having specific health conditions within their regional market, and to offer coupons and promotions through the mobile application interface.

Additionally, the infrastructure is able to display trends and aggregation of the data of the entire population of the social network; showing trends, participations by food industry members, and other useful data to create public policy decisions by national health entities and government health organizations.

### BRIEF DESCRIPTION OF THE DRAWINGS

FIG. 1 is a diagram outlining the function and form of the nutrition database infrastructure system.

FIG. 2 is a diagram of the web, mobile and social application features that are accessible through the user interface software.

FIG. 3 is a diagram showing the structure of data processing between the user interface, databases, and the map-reduce engine.

FIG. 4 is a diagram showing a detailed process of the map-reduce engine calculation.

FIG. 5 is a diagram showing the food logging process in the map-reduce engine calculation.

FIGS. 6 and 7 are diagrams showing one embodiment of the nutritional insights presented in a smart mobile device app.

FIG. 8 is a diagram showing an alternate embodiment screenshot of the user interface menu for Registered Dietitian users.

### DETAILED DESCRIPTION OF THE PREFERRED EMBODIMENT

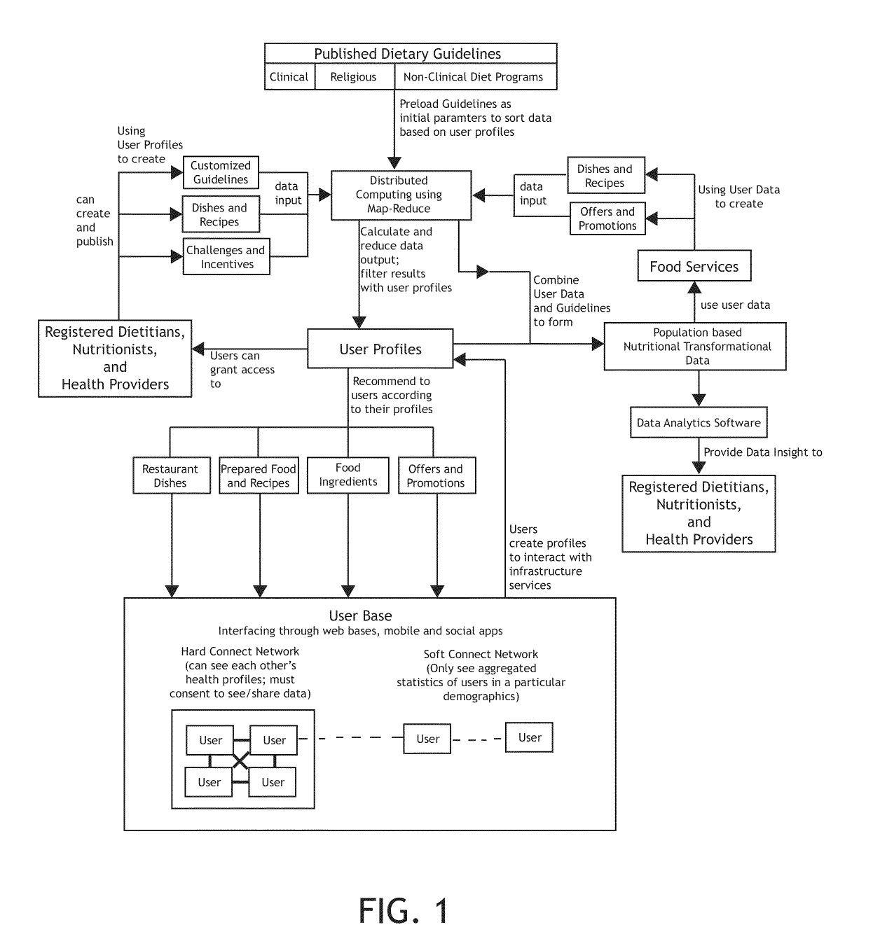

The preferred embodiment manifests as a computing infrastructure system that allows for easy data collection, analysis, and simple data output. Specifically, it uses a number of programmed components to allow a user to create or identify comparisons of food items against specific dietary needs and preferences. An example of the versatility and number of different aspects the infrastructure may have are detailed in FIG. 1.

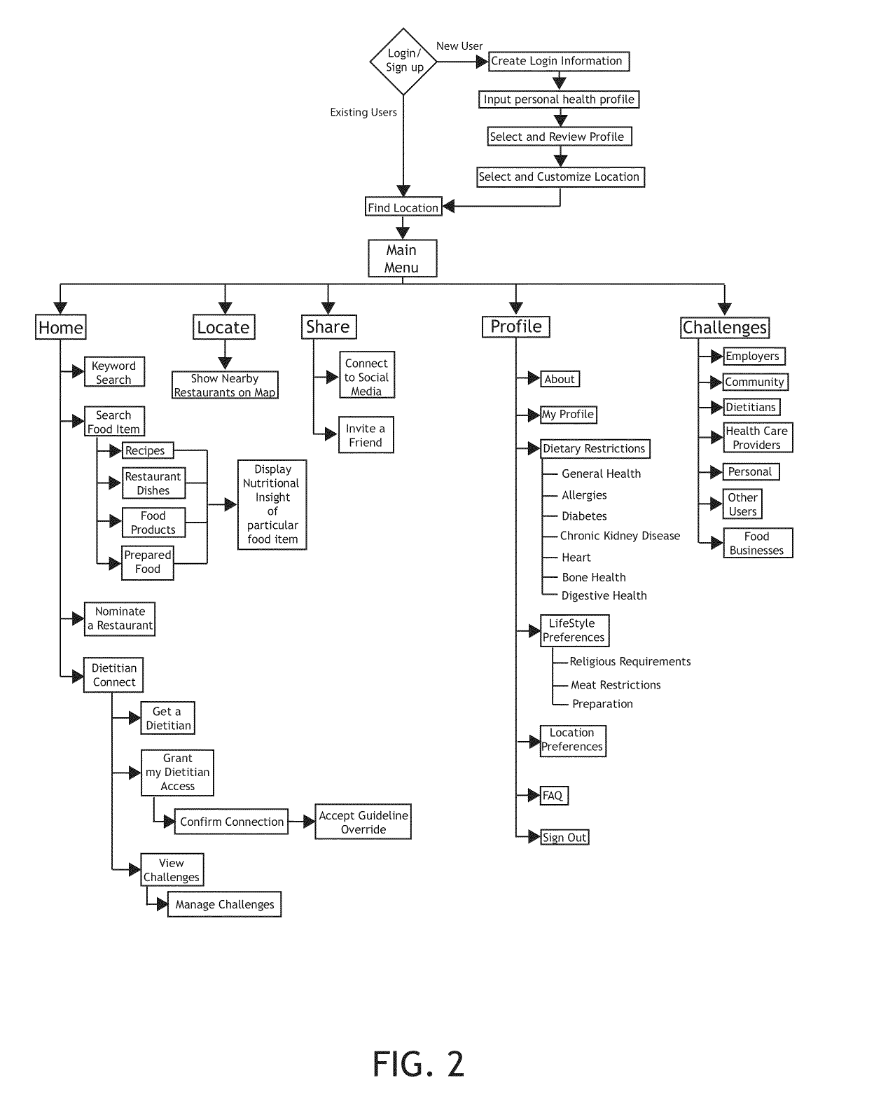

FIG. 2 displays an example table of features that may be available in the mobile app of the user interface software. It should be understood that other common methods of entering food items through barcode, and other means of food logging methods prevailing in the industry is covered by this patent application.

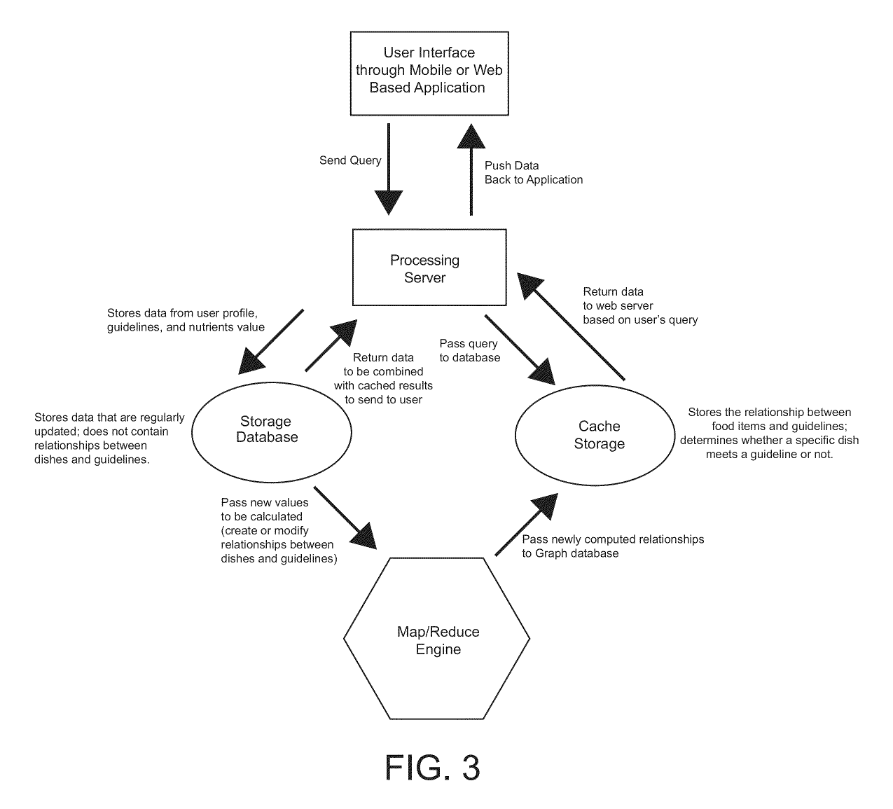

FIG. 3 defines the preferred embodiment's configuration of machines in order to use the infrastructure. A user may access the infrastructure through a web browser page or through an app installed in a mobile smart device such as smart phones and tablets. The user's machine is then connected to a processing server machine that regulates data traffic coming to and from the user's machine. The processing server machine is then connected to a first database. The first database store user profile database, nutrient database, health condition database, and food items database.

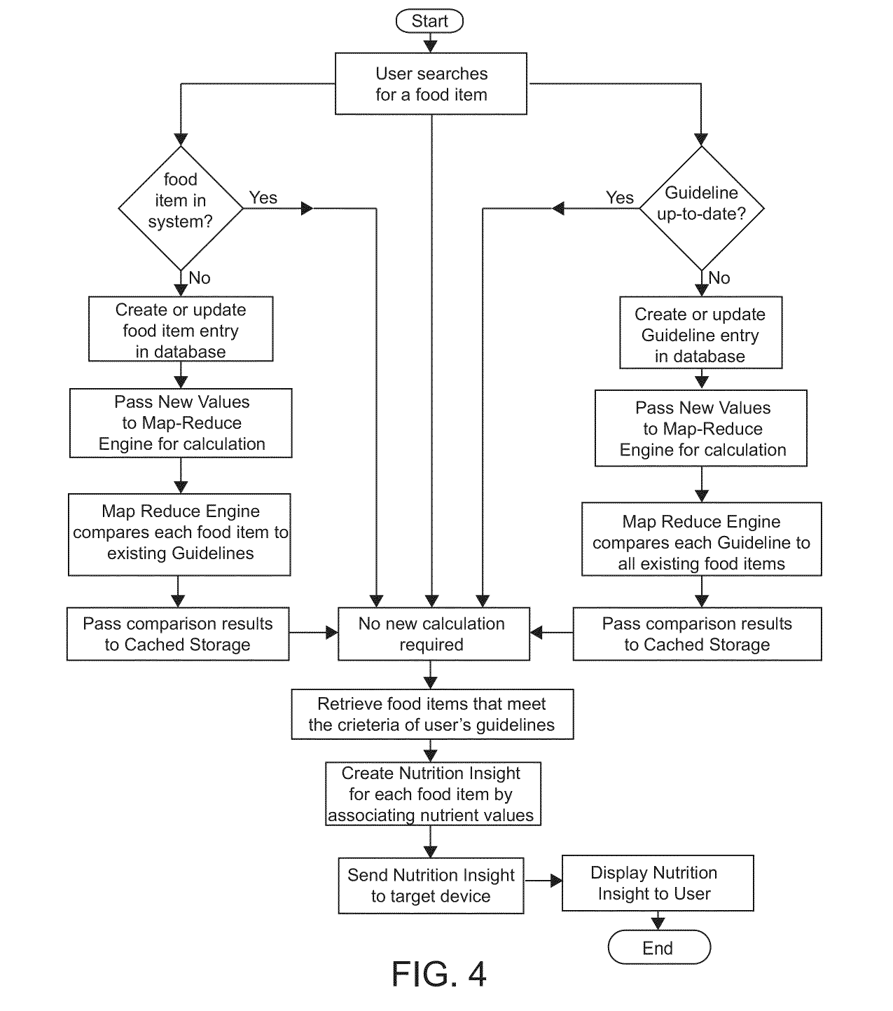

In FIG. 4, when a map-reduce calculation is performed, the map-reduce software retrieves data from the food item database, nutrient database, and health guidelines to be compared against. In order to save time and computing resources, only newly inputted or modified food items, nutrients, and health guidelines since the last process will be calculated by the map-reduce software. Therefore the largest calculation only occurs when the map-reduce software runs for the first time, because at that point every single food items in the database must be compared with every single guideline in the database.

The map-reduce software compares the amount of nutrients a food item contains with the amount of nutrients required in a particular health guideline. If a food item contains a nutrient that exceeds the required amount in a health guideline, the food item is identified in the system as not recommended for the particular guideline. A food item can qualify for a recommendation for a guideline only if all the nutrients present in the food item meets the requirements of that particular guideline. The results of the comparisons are then stored in a storage cache space to be accessed by the processing server when a user creates a query on a particular food item's nutrition insight.

Prior to any user input, the infrastructure is preloaded with a plurality of dietary guidelines as published or otherwise provided by recognized public health institutions, health associations, researchers, and others whom have developed customized dietary guidelines. These guidelines encompass data relating but not limited to age, weight, chronic condition or combination thereof, progression stage of a disease, gender, and combinations of multiple conditions, food preferences, preparation methods, and any other relevant factor. Guideline examples include restrictions on the intake of potassium and phosphorus or minimum recommended daily calcium intakes for a user of a certain age and gender. These guidelines serve as the building blocks for the advanced nutritional analysis.

In addition to the already known officially published guidelines, the application allows for the creation of additional guidelines by end users and these guidelines may be added to this Guidelines Database at any time. Therefore, anyone, including a physician, registered dietitian, certified diabetes educator, or whomever has been granted the ability to access the guideline creation system, can create a dietary guideline. Qualified and authorized professionals and users can also override a standard guideline provided for by the Guidelines Database and therefore create an alternate dietary guideline that the user can follow. These guidelines may be added through a guideline administration view that allows an organization or individual user to create custom guidelines to further optimize the guidelines in a given user profile.

In the preferred embodiment, the map-reduce function computes matches between food items and guidelines, as outlined in FIG. 4. Food items with their nutrients and nutritional facts are exported from the database. The map step of the map-reduce process parses the raw exported food item data from the database grouping nutritional facts for each food item together. The reducer step processes each group of food items' nutritional facts in parallel, matching them against guidelines for each of their respective nutrients. The resulting matching guidelines are written out by the map-reduce cluster to an output file containing all the food items with their nutritional facts and their guidelines.

When a new food item is added or changed, the infrastructure receives periodic updates from the database to process newly created dishes or updates to the dishes within the database. The map-reduce function then matches the dishes against all the guidelines from the database. The results of the dish to guideline matches are then stored in a cache, which in turn is queried when searching for food items.

When a guideline is added or modified, the infrastructure also receives periodic updates from the database to process any changes made to existing guidelines or newly created guidelines. The map-reduce function then matches the guidelines against all food items. Finally, the cache is updated with the new food item matches for the updated or new guidelines.

It is important to note that all calculations performed in the map-reduce process is entirely independent from user query process. Therefore when a user queries the system for a nutritional insight, the nutritional insight result is retrieved from the cached results, allowing a very fast response of the system.

When a user creates a profile within the system, the user will be required to enter his or her name, age, gender, height, weight, and activity level. The user can also enter any health conditions he or she may be aware of, and any other lifestyle preferences he or she may have. Health conditions can range from simple weight maintenance to more specific conditions that require stricter dietary guidelines such as hypertension, diabetes, bone disease, chronic kidney disease, and so forth. Lifestyle preferences include dietary restrictions from non-health related sources, such as religious restrictions, veganism, low carbohydrate diet, protein diet, and other diets practiced by people generally.

Using the data saved in the user profile, the system then associates a plurality of guidelines that match the health requirements of a user profile. For example, given a condition Hypertension with the following guidelines: (1) For females who are 18-25 and have an active lifestyle they should have no more than 500 mg of sodium; (2) for females who have an active lifestyle they should have 30 g of fiber; (3) for males who are 18-25 and have an active lifestyle they should have no more than 550 mg of sodium.

This is an example where a single condition has three guidelines associated with it. Continuing the example with a 20 year-old male user, if the user adds hypertension to his profile, when the profile is saved the processing server would look for all guidelines that are associated with hypertension that also match his profile data (gender, age, height, weight, activity level). The end result is his profile would be associated with hypertension and the user would have one guideline, the third one, associated with him.

In parallel, the computational analysis file system of the infrastructure maps and reduces large numbers of key, value relationships and performs on-the-fly computational analysis to relate guideline requirements to food attributes.

In the dish creation menu, the end user software application (both social and web-based) prompts the user for the ingredients they wish to use when creating a dish. If a required food item is not found in the database, the user can add it to the Food Database either manually or via an upload. The user can also select specific food brands or vendors that they wish to feature in dishes to speed the process of configuring dishes that incorporate ingredients from such vendors. These ingredients is then be analyzed first using standard nutrition calculation algorithms, and subsequently using proprietary code to compare an outputted Nutrition Profile with the Guidelines Database to compare food items against dietary guidelines and nutrition targets. The analytical results therefore can alert the user to which chronic health conditions are appropriate for the dish as each ingredient is added.

Suggestions for alternate items that compare more favorably with a guideline or nutrition target are made by the system based on complementary food groups or common pairings found in other dishes across the Food Database that would bring the dish into closer proximity to the nutrition targets. Users can add, subtract, and modify ingredients in real-time and the nutrition insights will be re-calculated based on any inputs. This information allows the user to indicate which food items compare more favorably to persons with various chronic conditions and who are taking a variety of prescriptions.

Past and present incidents or dishes that users choose to log also supplements the user profile. Specifically, the application creates a method that gives the user the ability to log the food he/she has eaten and how these foods may have affected his/her physiology in any way, be it positive or negative such as fatigue, nausea, sleep disorders, inflammation, or any other type of health incident. The user may also log the effects in conjunction with any medications or any treatments they might be pursuing. In this method, the user logs a personal health related incident that is logged in the Incident Database, citing any dishes they had consumed along with any side effects that may have occurred. End users can then choose to publish the dish within the Food Database so that other users can see these dishes when searching for recipes to prepare at home.

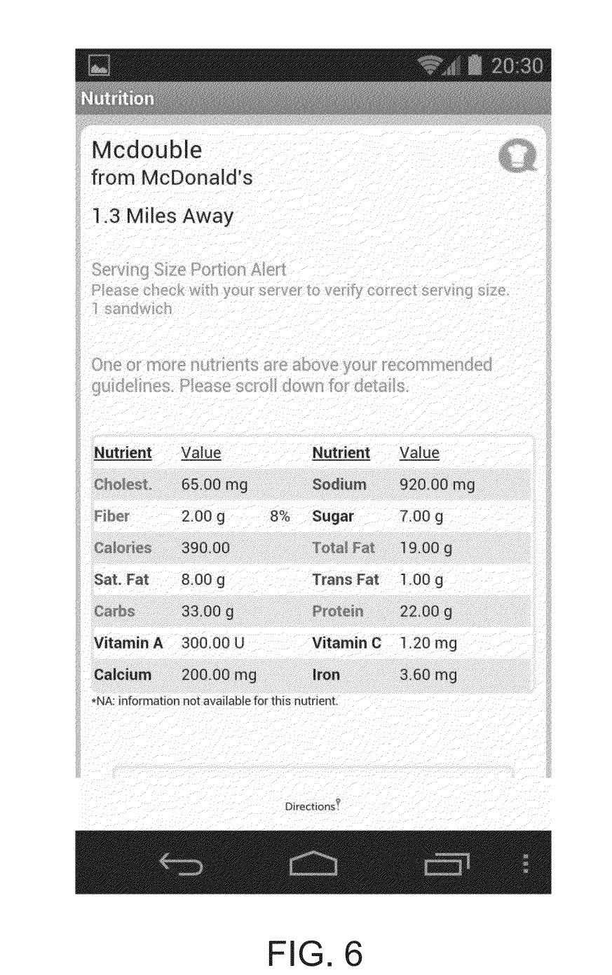

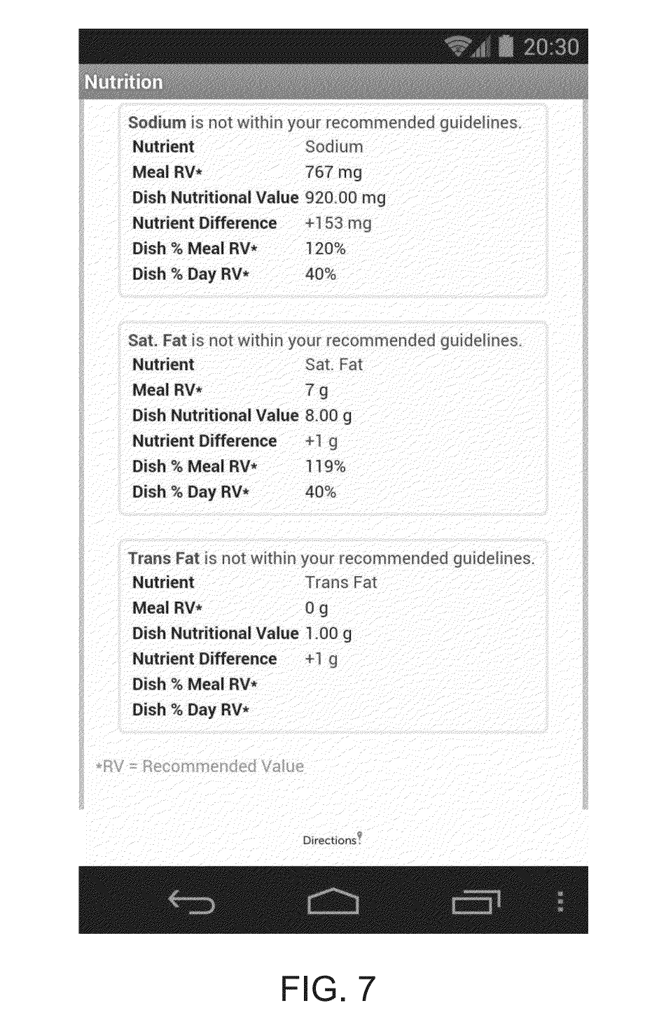

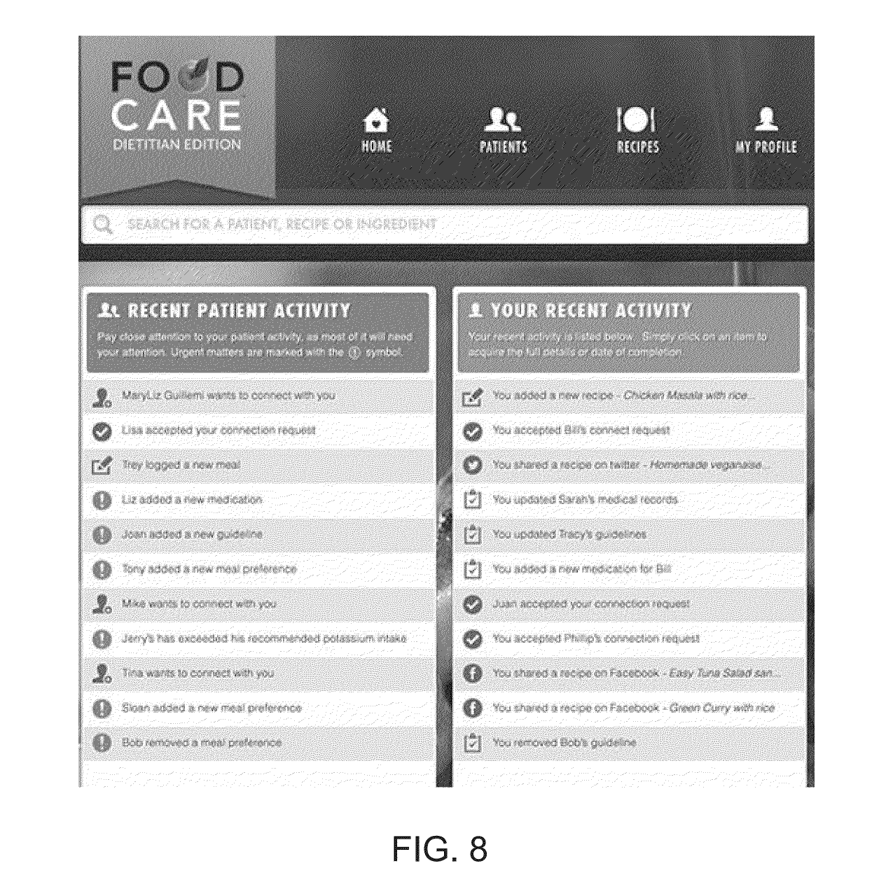

The final output of the map-reduce machine comes in the form of a nutrition insight of a particular food item, detailed in FIGS. 6 and 7. Here the user can see a particular food item's nutrient information as compared to the aggregated guidelines that have been previously assigned to the user profile. If a nutrient on the food item exceeds the daily Recommended Value (RV), the user is notified in the exact quantity by how many units the nutrients is exceed if the user eats the food item. The nutrients that are in excess of the recommended values established in the guidelines will be prominently displayed in a different colored text or other means to distinguish them from the rest of the displayed text so the user is immediately alerted to the issue.

Foodservice users can choose to receive macro-level nutrition insights (for example, across all guidelines configured in the system), or micro-level nutrition insights (for example, for a private client that has an individualized, personal dietary guideline configured by a Registered Dietitian). Foodservice users have the option of “publishing” a food item, in which case the status food item is changed such that the food item is viewable by all, or to a select grouping, of other users of the software application, as well as to users of other third party applications via the solutions Application Programming Interface. The Foodservice user can also use the food item to advertise to customers via an added promotion, which can be targeted towards users where there is an appropriate fit to the target ranges of an individual's dietary guidelines. If a Foodservice user elects not to publish a dish, it will not be displayed publicly from the Food Database, although it remains in the Food Database for internal professional or personal use purposes. Likewise, end users entering their own recipes can publish their dishes to a public repository accessed by other end users, primarily for use in home cooking.

In the dish or recipe creation interface available to Foodservice, Healthcare and consumer users, a real-time updating feature of the amount of ingredients related to the amount of nutrients is displayed to the users. Additionally, the interface can also display the number of population of potential consumers that can eat the dish, and such feature is present in the foodservice and health professional editions. In an example, a chef may add or remove ingredients to a dish and as he does so, he can see the amount of sodium in his dish as each ingredient is added to the dish. As the sodium level in the dish increases, the chef sees the number of potential customers decreasing because the sodium level would be beyond what is acceptable in the potential customer's health guidelines. Conversely, as the chef decreases or eliminates undesirable nutrients such as cholesterol or fat, the number of potential customers increase as the dish suddenly falls within a larger set of health guidelines shared over the population.

In addition to these guidelines, the infrastructure requires a user-built profile to provide an additional layer of precision to a particular user's health guideline. In this process, the application prompts the user with specific questions pertaining to their health, any medications they may be taking, and relevant demographic information. The user then inputs the medically related information based on facts provided by their doctor or other qualified health professional. The user has to complete a questionnaire based on their basic dietary and restaurant preferences. All of this information is added to the template to create a user profile which the application then associates with the user's preferences and settings.

This user-built profile is utilized in at least three ways. The first utility is to create a summary of his/her health data as it relates to food decisions being made as they relate to dishes overall health and appropriateness for their diet, and as well includes calculations of BMI and other standard health measurements. The summary is available for the user to view in an organized and easy to understand visualization.

The second utility allows the mobile application to complete the process for locating suitable food options. This method is the major method relevant to the end user and allows the user to locate relevant meals suitable for the consumer's consumption and in accordance with their health needs. In addition to the user profile, the mobile application receives input from the Guidelines Database and the Food Database, both discussed above, as well as query information input from the user at the time of request. The user can create a query based on factors such as location, food type preference, and cost. This query is then searched against the Food Database, eliminating any options that do not match the query.

The options are further narrowed down through a comparison against the user-profile and the relevant guidelines. Which guidelines are relevant is selected based on the user profile data. This narrowed list of options is the result of the user's query and is displayed in an easy to understand list. The list indicates where the dishes are located, their price range, which guidelines they meet, as well as other factors the user may use in deciding which restaurant to choose. The mobile application also has a feature for a user that is sharing multiple dishes with other people, here known as family style dining feature. The user can indicate the number of individuals sharing the dishes and the mobile application will calculate a rough estimate of how much of each dish the user can consume and enable the user to store an estimated nutrition profile of the user's meal from across the dishes.

The third utility of the user profile is for creating a health data dashboard that may be viewed and/or downloaded by a doctor, registered dietitians, or other health professionals. This dashboard serves as a patient population's management tool for said health professionals. The system itself serves as a method for data collection and collation as well as provide for a variety of standard reports based solely on the nutrition of the food consumed, as well as more advanced analytics relating to correlations between food consumed and vital statistics (changes in BMI, blood pressure, organ health, etc.). It can also leverage data provided by other third party devices or data providers (blood glucose monitors, internal vital statistic monitoring devices which report data wirelessly, etc.). The data is analyzed for use in this application, but it is also compiled into a document that can then but input into a third-party data warehouse for personal health records. Said data can then also be used to create reports and dashboards that the physician may log into via the third-party software.

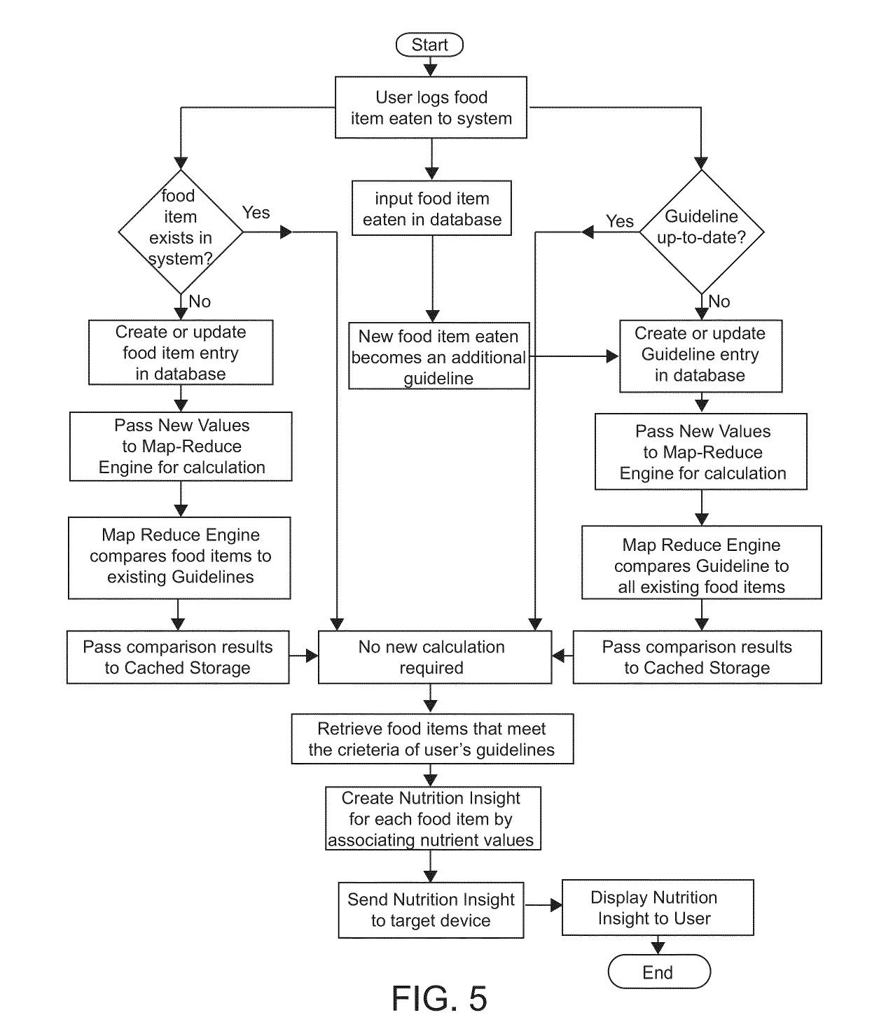

With the food logging process, the user may enter food items that the user has consumed throughout a day, as seen in FIG. 5. The amount of nutrients present in the food item logged by the user gets tracked in the first database. These amounts become an additional parameter for the map-reduce comparison process. Specifically, food items in the database that would exceed the daily recommended value would not be recommended to the user, because consuming that food item would bring the user's particular nutrient intake over the recommended value as established in his associated guidelines.

In addition to the databases, users can connect with other users of the infrastructure and create a social networking ecosystem within the system. Users can have direct connections in which a user grants other users complete access of their personal profile and guidelines. In this method of connection, the family dining feature automatically includes and cross reference the personal guidelines of other users in the friend list who are or will be present in the dining invitation. The application then filters the list of dishes and restaurants based on the aggregated personal guidelines of all the users in the list, and displays a list of dishes and restaurants that meet all the nutritional requirements of all the users in the list.

If users do not grant a direct connection with another user, the application still adds the other user as a friend, and instead displays a probable user profile based on the aggregated data of all user profiles existing within the infrastructure. The information displayed are the probabilities of known health conditions of the particular user in the age range, gender, ethnic group, and lifestyle habits relative to the population.

The network infrastructure is also capable of becoming a platform for web based API. This allows web communities to create open architecture for sharing content and data between communities and applications. In this manner, content that is created in one place can be dynamically posted and updated in multiple locations on the web. Having this in mind, the infrastructure is designed to become a nutritional analysis backbone to online web communities and services that focus on providing information and services related to food and nutritional health.

Another aspect of the infrastructure is the ability to create and offer health incentives for users from different sources. The health incentives include coupons and promotions to be used in participating food service establishments, and health challenges by various sources that users can participate in. The challenges are made by food service providers, health professionals, even among the users themselves to develop healthy living habits among users who participate in the challenges. In the preferred embodiment, the challenges are customized to the user's personal profile and health guidelines. Users can also create their own challenges, creating self-challenges or challenges for other users to participate in. The challenges can be individual in nature, or can be in the form of group participation. Completion and the outcome of the challenges are then recorded in the user's profile and users can see their achievements over time.

The foregoing description of the preferred embodiment of the invention have been presented for purposes of illustration and description. It is not intended to be exhaustive or to limit the invention to the precise form disclosed. Modifications or variations are possible and contemplated in light of the above teachings by those skilled in the art, and the embodiments discussed were chosen and described in order to best illustrate the principles of the invention and its practical application. It is intended that the scope of the invention be defined by the claims appended hereto.

We claim:

1. A method for computing the nutrition insights for food items, comprising:
(a) Storing a plurality of dietary guidelines related to nutrients, ingredients, and lifestyle preferences into a first database;
(b) Assigning a method of calculation for a specified nutrient; wherein said method of calculation comprises:
(i) A threshold method; wherein a nutrient has an either minimum value that has to be fulfilled in a given day or a maximum value that cannot be exceeded in a given day based on at least one dietary guideline requirements;
(ii) A targeted method, comprising the steps:
Giving a nutrient a range of acceptable values depending on the characteristic of the nutrient within a particular health condition or dietary preference,
Comparing the amount of a nutrient in a food item with said range of acceptable values,
Assigning a score such that the closer the nutrient amount in a food item comes to the target value for the nutrient, the higher the score the food item receives.
(c) Storing user profile into said first database, wherein said user profile further comprises:
(c)(i) user name,
(c)(ii) height,
(c)(iii) weight,
(c)(iv) age,
(c)(v) gender, and
(c)(vi) activity level;
(d) Storing dietary information on said first database, wherein said dietary information comprises
(d)(i) a food item database, wherein said food items comprises
(d)(i)(i) an ingredient,
(d)(i)(ii) a singular food item,
(d)(i)(iii) a dish,
(d)(i) (iv) a recipe,
(d)(ii) a nutrient values database,
(d)(iii) an ingredient attributes database,
(d)(iv) a health conditions database,
(d)(v) and a lifestyle preferences database;
(e) Storing other relevant user information on said first database;
(f) Creating an association between said user profile and at least one of said standardized guidelines based upon data from said user profile, said dietary information, and said other relevant user information;
(g) Using a map-reduce software to map each new recipe or new food item's nutrients into a unit of work;
(h) Using a map-reduce software to reduce the units of work by comparing the nutrients for each said new food item or new recipe against all defined guidelines;
(i) Storing the results of said comparisons a cache for subsequent retrieval without recomputation;
(j) Repeating the process of steps (g) through (i) for any new entries discovered since the prior process.

2. The method of claim 1, further comprising:
(d)(i) Food items consumed by said user in a one day period.

3. The method of claim 1, further comprising:
(b)(iii) Using the targeted method for the nutrients calcium and dietary fiber.

4. A method for providing nutritional insight to a user comprising:
(a) Having a user create a user profile, wherein said user profile comprises name, age, gender, height, weight, activity level, and at least one health condition;
(b) Assigning a plurality of standardized guidelines that are suitable to said user profile based on the information stored in said user profile;
(c) Retrieving a plurality of food items and recipes that have been previously compared with all of the standardized guidelines present in the system;
(d) Presenting nutritional insights of said food items to the user,
wherein said food items are displayed with their actual nutrient values compared to the recommended values as defined in said standardized guidelines,
and said food items that are meet the requirements of the user's dietary guidelines are indicated as such in the display.

5. The method of claim 4, where step (b) further comprising:
(b)(i) Connecting said user to a Registered Dietitian, where said Registered Dietitian evaluates the health guidelines associated to said user and create further customization to better suit said user's health profile.

6. An apparatus communicating nutritional insights to and from a computer to a user comprising:
(a) The internet;
(b) A user machine operably connected to said internet;
(c) A user interface program installed on said user machine;
(d) A first database comprised of a dish/recipe database, a user profile database, a nutrients database, a health conditions database, and a health guidelines database,
wherein said user profile and health conditions create a plurality of comparison criteria stored in the health said guidelines database;
(e) A plurality of computers operably connected to both said internet and said plurality of databases, operating as a processing server,
wherein said computers are adapted to send and receive data from the user client interface machine, said first database, and only receiving data from said second database;
(f) A map-reduce calculation software running in said plurality of computers,
wherein said map-reduce calculation software receives data from said first database and compares dishes and recipes to said health guidelines and output dish and recipe that matches the criteria set on said health guideline;
(g) A storage area for storing cached comparison results of said map-reduce calculations;
(h) At least one process server machine operably connected to said first database, and said second database,
wherein said process server machine regulates traffic from and to said user machine,
wherein said process server machine passes any new data from user to said first database to be calculated by said map-reduce software;
wherein said process server machine retrieves said cached comparison results and assemble nutritional insights to be transmitted to said user's machine.

7. The apparatus of claim 6, where the user machine is a computer.

8. The apparatus of claim 6, where the user machine is a smart mobile device.

9. The apparatus of claim 6, where the user client interface is a smart mobile app.

10. The apparatus of claim 6, where the user client interface is a web browser.
